(19) United States
(12) Patent Application Publication
(10) Pub. No.: US 2026/0326361 A1
(43) Pub. Date: Oct. 22, 2026

(54) SMART THERMOPLASTIC COMPOSITES

(71) Applicant: Indian Institute of Technology Bombay, Mumbai (IN)

(72) Inventors: Kushal Manoj Soni, Mumbai (IN); Sagar Dyandeo Talele, Mumbai (IN); Arun G. Krishnan, Mumbai (IN); Tapas Pandey, Mumbai (IN); Rupesh Eknath Ghyar, Mumbai (IN); Ravi Bhallamudi, Mumbai (IN)

(21) Appl. No.: 19/697,413

(22) Filed: Jun. 3, 2026

Related U.S. Application Data
(63) Continuation of application No. PCT/IN2024/052325, filed on Dec. 3, 2024.

(30) Foreign Application Priority Data
Dec. 3, 2023 (IN) 202321082175

(51) Int. Cl. B29C 53/84; B29C 53/02

(52) U.S. Cl. CPC B29C 53/84; B29C 53/02

(57) ABSTRACT

Smart thermoplastic composites comprising: at least a thermoplastic component (12) having a first cross-sectional profile; at least a thermal component (14) having a second cross-sectional profile and interfacing with said thermoplastic component (12); wherein, the cross-sectional arrangement is such that, the thermal component (14) modified the thermal nature of the thermoplastic component in either its hot-active state or in its cold-active state ensuring that there is a pliable region of deformation within said thermoplastic component (12) by creating a controlled thermal gradient within a region or volume of interest in said thermoplastic component (12) by: increasing localised temperature, of said thermoplastic component (12), above its softening point but below its viscous temperature; and maintaining ambient temperature above its softening point and maintaining localised temperature below its softening point.

### RELATED APPLICATIONS

This application claims priority under 35 U.S.C. § 120 to, and is a continuation of, co-pending International Application PCT/IN2024/052325, filed Dec. 12, 2024 and designating the US, which claims priority to IN application Ser. No. 20/2321082175, filed Dec. 3, 2023, such IN Application also being claimed priority to under 35 U.S.C. § 119. These IN and International applications are incorporated by reference herein in their entireties.

### FIELD

This invention relates to the field of materials and electro-mechanics.

Particularly, this invention relates to the field of functional materials comprising combinatorial components comprising thermoplastic components and non-thermoplastic components.

More particularly, this invention relates to a variable stiffness combinatorial material.

Specifically, this invention relates to smart thermoplastic composites.

### BACKGROUND

In engineering, ‘deformation’ refers to change in size or shape of an object. Depending on type of material, size and geometry of the object, and forces applied, various types of deformation may result.

FIG. 1 illustrates a typical stress vs. strain diagram indicating various stages of deformation along with elastic region, plastic region, and fracture region.

In elastic deformation, the deformation is temporary that can be undone simply by removing applied force. This is self-reversing intrinsic property of a material.

In plastic deformation, the deformation is not undone simply be removing applied force. Thermoplastics, with high chain mobility, have a rather large plastic deformation range. Temperature induced chain mobility is used in the proposed invention to attain a viscoelastic state that allows for higher levels of deformation.

The increase in temperature is used in “colder” ambient settings for desired deformation using internal thermal element(s), and inversely, in “hotter” ambient settings, internal thermal element is used to get the thermoplastic out of the viscoelastic state into a desired high stiffness state.

### SUMMARY

There is a need to invent materials with extendable plastic deformation ranges.

An object of the invention is to provide on-demand shapable materials.

Another object of the invention is to provide on-demand re-shapable, reusable, materials.

Yet another object of the invention is to provide a breathable, low footprint, and reformable composite material.

According to this invention, there are provided smart thermoplastic composites comprising: at least a thermoplastic component having a first cross-sectional profile; at least a thermal component having a second cross-sectional profile and interfacing with said thermoplastic component; wherein, the cross-sectional arrangement is such that, the thermal component modified the thermal nature of the thermoplastic component in either its hot-active state or in its cold-active state ensuring that there is a pliable region of deformation within said thermoplastic component by creating a controlled thermal gradient within a region or volume of interest in said thermoplastic component by: increasing localised temperature, of said thermoplastic component, above its softening point but below its viscous temperature; and maintaining ambient temperature above its softening point and maintaining localised temperature below its softening point.

In at least an embodiment, said composite being engaged with:
an energy source configured to enable transmission of energy between said thermal component and said thermoplastic component; and
an energy sink configured to enable absorption of energy between said thermal component and said thermoplastic component;
a control mechanism configured to achieve a pliable region of deformation, within said thermoplastic component, upon receipt of said transmitted energy, by creating a controlled thermal gradient within a region or volume of interest in said thermoplastic component, by: controlling said transmission of energy in a first chosen unidirectional manner and to control said absorption of energy in a second chosen unidirectional manner, each of said first chosen unidirectional manner and said second chosen unidirectional manner never being the same direction; controlling said transmission of energy between a viscous point of said thermoplastic component and a softening point of said thermoplastic component.

In at least an embodiment, said interfacing is selecting from a group of interfacing types selected from thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, partially ensconced interfacing with the thermal component partially ensconcing the thermoplastic component.

In at least an embodiment, said thermoplastic being activated in its hot active mode of working, in that, energy control, vide a control mechanism, from an energy source to an energy sink being controlled such that thermoplastic temperature (Tt) being more than thermoplastic viscous temperature (Tv/Tm) but being less than thermoplastic softening temperature (Tg).

In at least an embodiment, said thermoplastic being activated in its hot active mode of working, in that, energy control, vide a control mechanism, from an energy source to an energy sink being controlled such that temperature (Tsource) of said energy source being greater than or equal to temperature (Tth) of said thermal component, temperature (Tth) of said thermal component (14) being greater than or equal to temperature (Ttp) of said thermoplastic component, temperature (Ttp) of said thermoplastic component being greater than or equal to temperature (Tsink) of said energy sink.

In at least an embodiment, said thermoplastic being activated in its cold active mode of working, in that, energy control, vide a control mechanism, from an energy sink to an energy source being controlled such that thermoplastic temperature (Tt) being more than thermoplastic softening temperature (Tg) but being less than thermoplastic viscous temperature (Tv/Tm).

In at least an embodiment, said thermoplastic being activated in its cold active mode of working, in that, energy control, vide a control mechanism, from an energy sink to an energy source being controlled such that temperature (Tsource) of said energy source being lesser than or equal to temperature (Tth) of said thermal component, temperature (Tth) of said thermal component being lesser than or equal to temperature (Ttp) of said thermoplastic component, temperature (Ttp) of said thermoplastic component being lesser than or equal to temperature (Tsink) of said energy sink.

In at least an embodiment, said thermal component, being a non-thermoplastic component, acting as an internal thermal source.

In at least an embodiment, said thermal component, being a non-thermoplastic component, composed of a polar compound or a dielectric material, when intercepted by electromagnetic radiation of corresponding frequency, acting as a heat source.

In at least an embodiment, said thermal component, being a non-thermoplastic component, which is in thermal contact with an external heat source and said thermoplastic component.

In at least an embodiment, for said thermal component acting as an energy source, said control mechanism configured to achieve a pliable region of deformation, within said thermoplastic component, upon receipt of said transmitted energy, by creating a controlled thermal gradient within a region or volume of interest in said thermoplastic component, by:

maintaining ratio (V_{E}) of loss modulus, of said thermoplastic component to storage modulus of said thermoplastic component be greater than or equal to 1.

In at least an embodiment, for said thermal component acting as an energy sink, said control mechanism configured to achieve a pliable region of deformation, within said thermoplastic component, upon receipt of said transmitted energy, by creating a controlled thermal gradient within a region or volume of interest in said thermoplastic component, by:
maintaining ratio (V_{E}) of loss modulus, of said thermoplastic component to storage modulus of said thermoplastic component be lesser than 1.

According to this invention, there is provided a smart thermoplastic composite system comprising:
at least a thermoplastic component;
at least a thermal component interfacing with said thermoplastic component;
an energy source configured to enable transmission of energy between said thermal component and said thermoplastic component; and
an energy sink configured to enable absorption of energy between said thermal component and said thermoplastic component;
a control mechanism configured to achieve a pliable region of deformation, within said thermoplastic component, upon receipt of said transmitted energy, by creating a controlled thermal gradient within a region or volume of interest in said thermoplastic component, by: controlling said transmission of energy in a first chosen unidirectional manner and to control said absorption of energy in a second chosen unidirectional manner, each of said first chosen unidirectional manner and said second chosen unidirectional manner never being the same direction; controlling said transmission of energy between a viscous point of said thermoplastic component and a softening point of said thermoplastic component.

In at least an embodiment, said control mechanism configured to achieve a pliable region of deformation, within said thermoplastic component, upon receipt of said transmitted energy, by creating a controlled thermal gradient within a region or volume of interest in said thermoplastic component, by:
increasing localised temperature, of said thermoplastic component, above its softening point but below its viscous temperature; and
maintaining ambient temperature above its softening point and maintaining localised temperature below its softening point.

In at least an embodiment, said interfacing is selecting from a group of interfacing types selected from thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, partially ensconced interfacing with the thermal component partially ensconcing the thermoplastic component.

In at least an embodiment, said transmission of energy and said absorption of energy being in the form of conduction, convection, and/or radiation.

In at least an embodiment, said control being selectable from a group of controls consisting of electrical control, pressure control, volume control, chemical control, electromagnetic irradiance control, mechanical force control, magnetic field control, flow rate control, acoustic heating control, and acoustic cooling control.

In at least an embodiment, said thermoplastic being activated in its hot active mode of working, in that, energy control, vide said control mechanism, from said energy source to said energy sink being controlled such that thermoplastic temperature (Tt) being more than thermoplastic viscous temperature (Tv/Tm) but being less than thermoplastic softening temperature (Tg).

In at least an embodiment, said thermoplastic being activated in its hot active mode of working, in that, energy control, vide said control mechanism, from said energy source to said energy sink being controlled such that temperature (Tsource) of said energy source being greater than or equal to temperature (Tth) of said thermal component, temperature (Tth) of said thermal component being greater than or equal to temperature (Ttp) of said thermoplastic component, temperature (Ttp) of said thermoplastic component being greater than or equal to temperature (Tsink) of said energy sink.

In at least an embodiment, said thermoplastic being activated in its cold active mode of working, in that, energy control, vide said control mechanism, from said energy sink to said energy source being controlled such that thermoplastic temperature (Tt) being more than thermoplastic softening temperature (Tg) but being less than thermoplastic viscous temperature (Tv/Tm).

In at least an embodiment, said thermoplastic being activated in its cold active mode of working, in that, energy control, vide said control mechanism, from said energy sink to said energy source being controlled such that temperature (Tsource) of said energy source being lesser than or equal to temperature (Tth) of said thermal component, temperature (Tth) of said thermal component being lesser than or equal to temperature (Ttp) of said thermoplastic component, temperature (Ttp) of said thermoplastic component being lesser than or equal to temperature (Tsink) of said energy sink.

In at least an embodiment, said thermal component, being a non-thermoplastic component, acting as an internal thermal source.

In at least an embodiment, said thermal component, being a non-thermoplastic component, composed of a polar compound or a dielectric material, when intercepted by electromagnetic radiation of corresponding frequency, acting as a heat source.

In at least an embodiment, said thermal component, being a non-thermoplastic component, which is in thermal contact with an external heat source and said thermoplastic component.

In at least an embodiment, for said thermal component acting as an energy source, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be greater than or equal to 1.

In at least an embodiment, for said thermal component acting as an energy sink, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be lesser than 1.

### BRIEF DESCRIPTION OF THE ACCOMPANYING DRAWINGS

FIG. 1 illustrates a typical stress vs. strain diagram indicating various stages of deformation along with elastic region, plastic region, and fracture region.

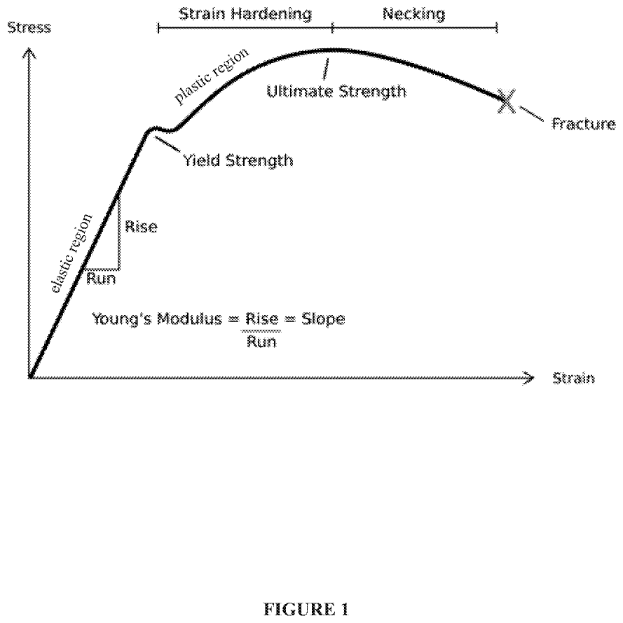

The invention will now be described in relation to the accompanying drawings, in which:

FIG. 2 illustrates a schematic block diagram for the smart thermoplastic composite of this invention;

FIG. 3 is an illustration showing an embodiment of the invention with a thermal component embedded inside a thermoplastic and an external energy source providing energy to the core which thereby causes change in the temperature of thermoplastic;

FIG. 4 illustrates a block diagram which enables the ‘smartness’ of the smart thermoplastic composites;

FIG. 5 illustrates a block diagram which enables the ‘smartness’ of the smart thermoplastic composites in accordance with its various modes of working;

FIGS. 6a, 6b, 6c, and 6d illustrate various configurations, in terms of cross-sectional views, of the smart thermoplastic composite of this invention.

### DETAILED DESCRIPTION

According to this invention, there are provided smart thermoplastic composites.

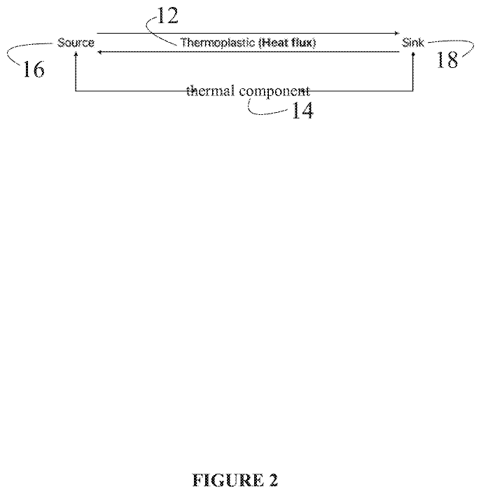

FIG. 2 illustrates a schematic block diagram for the smart thermoplastic composite of this invention.

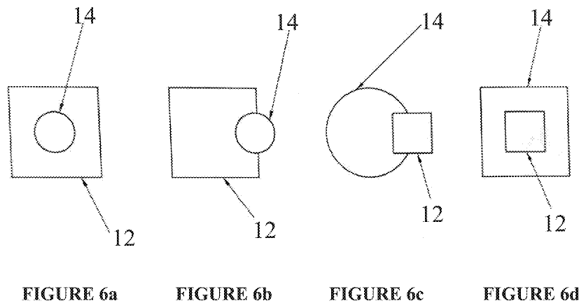

FIGS. 6a, 6b, 6c, and 6d illustrate various configurations, in terms of cross-sectional views, of the smart thermoplastic composite of this invention.

In at least an embodiment, the present invention concerns a composite material or a combinatorial material, comprising at least a thermoplastic component (12) and at least a thermal component (14) coupled with the thermoplastic component (12). Additionally, the present invention concerns a composite material or a combinatorial material, particularly being a smart composite, comprising at least an energy source (16) and an energy sink (18).

The placement of the thermoplastic component (12) and the thermal component (14), with respect to each other, is such that thermal energy should be passed from one to the other in a bidirectional manner-however, not simultaneously in both directions, the passing may be in the form of conduction, convection, and/or radiation.

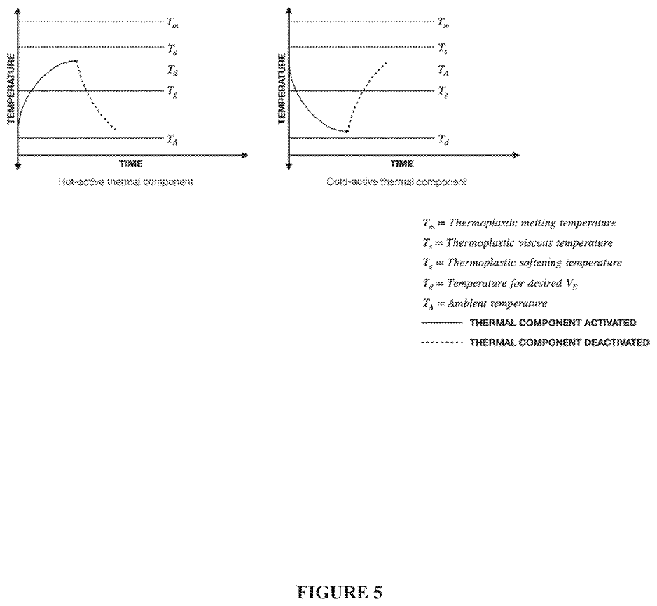

The interface between the thermoplastic component (12) and the thermal component (14) may be one of many configurations as seen in FIG. 5 of the accompanying drawings.

In at least an embodiment, as seen in FIG. 6a, of the accompanying drawings, the thermal component (14) is completely ensconced within the thermoplastic component (12).

In at least an embodiment, as seen in FIG. 6b, of the accompanying drawings, the thermal component (14) is partially ensconced within the thermoplastic component (12).

In at least an embodiment, as seen in FIG. 6c, of the accompanying drawings, the thermoplastic component (12) is partially ensconced within the thermal component (14).

In at least an embodiment, as seen in FIG. 6d, of the accompanying drawings, the thermoplastic component (12) is completely ensconced within the thermal component (14).

For the purposes of this invention, viscous point of given thermoplastic is defined as a temperature at which the loss modulus of the thermoplastic is such that the displacement of the thermal element may occur due to the thermally induced viscosity in the thermoplastic. Whereas, the softening point of the given thermoplastic is defined as a temperature at which the loss modulus becomes equal to storage modulus, thereby becoming pliable. The ratio of loss modulus and storage modulus is defined as V_{E}.

In at least an embodiment, the thermal component (14), being a non-thermoplastic component, acts as an internal thermal source that works on the basis of Ohmic heating (using a resistance wire) or Thermoelectric heating (using a Thermocouple). Electric current for the thermal component (14) generates heat for these by eddy currents due to electromagnetic induction or electric current directly supplied to the conductor by conduction. This configuration facilitates ‘electric heating.’

In at least an embodiment, the thermal component (14), being a non-thermoplastic component, which can be composed of a polar compound or a dielectric material, when intercepted by electromagnetic radiation of the corresponding frequency, this acts as a heat source. One of the embodiments of this configuration can be a channel in the volume of the thermoplastic, filled with this thermal component (14). Another embodiment of the same can be a thermal component (14) scattered throughout the volume of the thermoplastic in the form of a suspended additive. This configuration facilitates ‘heating by way of electromagnetic radiation, and/or induction (near-field).

In at least an embodiment, the thermal component (14), being a non-thermoplastic component, which is in thermal contact with an external heat source and the thermoplastic. In such a configuration, the thermal component (14) acts as a conductor between a heat source by transferring the heat from the “hotter” external heat source to the thermoplastic in a “colder” ambient environment. Inversely, the thermal element may act as a conductor between a thermal sink in “hotter” ambient environment to increase the localised stiffness of the thermoplastic component. This configuration facilitates ‘contact heat transfer.’

In at least an embodiment, the source (16) passes energy to the thermal component.

In some embodiments, shape memory materials may be used, as a thermal component (14), that can apply a force on the thermoplastic component at particular temperatures and even be trained at other temperatures. Properties and characteristics of such materials need to be considered:
Martensitic Transformation Temperature
Austenitic Transformation Temperature
Degree of Deformation
Programming temperature (Shape memory polymers)
Recovery temperature

Additionally, non-contact forces may also act on the composite, the non-contact forces being:
Gravity may be used to use the weight acting on the volume of interest in the embodiment;
Magnetic field acting on the volume of interest in the embodiment;
Static electric forces acting on the volume of interest in the embodiment.

In some embodiments, combination of externally acting contact forces may be used to deform or hold a form of the combined composite of this invention.

In some embodiments, combination of contact and non-contact forces may be used to deform or hold a form of the combined composite of this invention.

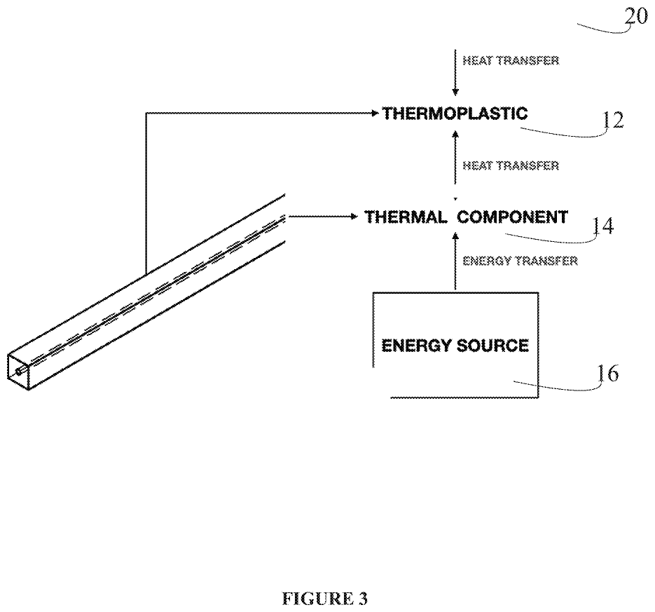

FIG. 3 is an illustration showing an embodiment of the invention with a thermal component (14) embedded inside a thermoplastic and an external energy source providing energy to the core which thereby causes change in the temperature of thermoplastic

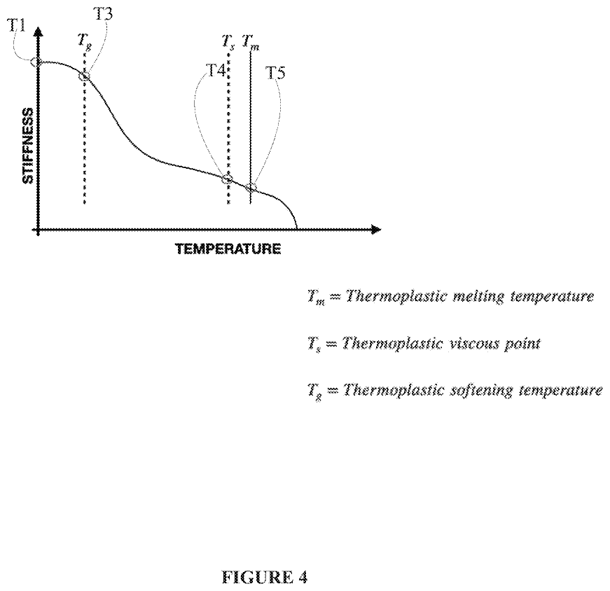

FIG. 4 shows the relationship between the stiffness of a thermoplastic at different temperatures.

In its active state, the thermal component (14) either acts as a thermodynamic/energy sink (absorbing heat/energy) (18) or a thermodynamic/energy source (emitting heat/energy) (16), while its ambient environment (20)/entity becomes relatively opposite in direction or flow. The thermoplastic component (12) acts as a conductor/transmitter between them, facilitating transfer/transmission of heat between the thermal component (14) and the ambient environment (20), when there is a temperature difference between the two (14, 20).

The active state of this invention's smart composite material is characterized by application of an external energy vector to the thermal component (14), which creates a controlled thermal gradient within a region or volume of interest in the thermoplastic component (12). This gradient results in localized temperature changes, thereby allowing for a desired localised change in viscoelastic properties of the thermoplastic. The active state of the composite is defined as a state when an external energy vector acting on the thermal component (14) creates a controlled thermal gradient in the region/volume of interest of the thermoplastic component (12). There are two embodiments of this:
1. The localised temperature increases above the softening point but below a viscous temperature of the thermoplastic (12).
2. The ambient temperature is above the softening point, and localised temperature is brought below by the thermal component (14).

Upon transfer of energy to the non-thermoplastic component (14) from a source (16), there is rise in temperature of the non-thermoplastic component (14) above a threshold temperature. It thereby transfers heat to the thermoplastic component (12), allowing the thermoplastic component (12) to allow manipulated deformation, into a desired geometry upon application of force(s) or stress(es).

Subsequently, on discontinuation of energy supply to the thermal component (14), the embodiment of the composite is cooled down through active or passive means, allowing it to maintain its geometry.

Conversely, the thermal component (14) may be used to transfer heat out of the thermoplastic (12) using a heat sink (18) or a cooler to increase stiffness of the embodiment. This composite along with the combinatorial heat transfer method enables controlled deformation for various applications.

In at least an embodiment, the thermal component (14), being a non-thermoplastic component, is an energy source (16). The heat transfer from the thermal component (14) (non-thermoplastic component) to the thermoplastic component (12) is facilitated by conduction and/or convection and/or radiation. The heat flux, at the contact, or at the point of transfer, is such that the thermoplastic is not able to flow. The net heat flow through the thermoplastic is such that the surface temperature of the farthest surface from the thermal component (14) is adequate to change the V_{E} to ≥1. Here, in its active state:
Thermal component (14) in the volume of the thermoplastic (12): The temperature distribution diverges from a unit of the thermal component (14) into a volume of interest in the thermoplastic (12);
Thermal component (14) outside the volume of the thermoplastic (12), both in a contact;
Thermal component (14) and the thermoplastic (12) have a surface contact.

In at least an embodiment, the thermal component (14), being a non-thermoplastic component, is an energy sink (18). The heat transfer to the thermal component [non-thermoplastic component] (14) from the thermoplastic component (12) is facilitated by conduction and/or convection and/or radiation. The heat flux, at the contact, or at the point of transfer, is such that the thermoplastic remains stiff due to cooling of the thermoplastic by the thermal component (14). Here, in its active state:
Thermal component (14) in the volume of the thermoplastic (12): temperature distribution converges to a unit of the thermal component (14) into a volume of interest in the thermoplastic (12);
Thermal component (14) outside the volume of the thermoplastic (12), both in a contact;
Thermal component (14) and the thermoplastic (12) have a surface contact.

There could be one or more methods for varying temperature/s of the thermal component (14), the methods being selectable from:
Electric power: Control the electrical current, voltage to the non-thermoplastic component using resistive heating elements, thermoelectric devices, or other electrical heating/cooling mechanisms like Peltier cooling.
Pressure: Control the pressure in the system to change the temperature of the non-thermoplastic component through processes like compression or expansion.
Volume: Control the volume in the system to change the temperature of the non-thermoplastic component while holding the pressure constant.
Chemical Reactions: In thermo-chemical thermal component, control the rate and extent of chemical reactions in the thermal component to release or absorb heat.
Electromagnetic Irradiance: Control the exposure to radiation, intensity, luminosity with respect to the thermal component.
Mechanical Force: Controlling mechanical work, which can be converted into heat energy using friction or other processes.
Magnetic Field: In magnetic refrigeration or induction heating systems, control the magnetic field to manipulate the temperature of the thermal component.
Flow Rate: Control the flow rate of a heat transfer fluid to vary the heat exchange with the non-thermoplastic component.
Acoustic heating/cooling: Control the amplitude, frequency of a thermoacoustic heat pump working on the thermal component.

FIG. 4 illustrates a block diagram which enables the ‘smartness’ of the smart thermoplastic composites.

As seen in FIG. 4,
Tm=Thermoplastic (12) melting temperature
Ts=Thermoplastic (14) viscous temperature
Tg=Softening temperature
Tsource=Temperature of source
Tsink—Temperature of sink
Tt=thermoplastic component (12) temperature
Tc=thermal component (14) temperature

FIG. 5 illustrates a block diagram which enables the ‘smartness’ of the smart thermoplastic composites in accordance with its various modes of working.

In order to efficiently work these smart composite materials, according to this invention, the following rules, of engagement, are followed.

In its hot active mode of working, direction of energy flow is from source to sink such that:
Tm<Tt<Tg
Tsource>=Tc>=Tt>=Tsink

In its cold active state, direction of energy flow is from sink to source such that:
Tm>Tt>Tg
Tsource<=Tc<=Tt<=Tsink

Reference numeral T1=crystallisation temperature (temperature at which maximum stiffness is achieved)
Reference numeral T2=softening temperature
Reference numeral T3=glass transition temperature
Reference numeral T4=viscous point/temperature
Reference numeral T5=melted temperature (temperature at which least stiffness/fluidity is achieved)

Region between T2 and T4=pliable region—where the smart composite of this invention is highly deformable with least effort “force” for forces like gravity.

In order to achieve this balance; the following parameters are considered:
A_{CT}: Contact area between the thermal element and the thermoplastic.
A_{CA}: Surface area of the thermal element exposed to air.
A_{S}: Surface area of the thermoplastic exposed to the ambient environment.
A_{C}: Cross-sectional area of the thermal element.
A_{T}: Cross-sectional area of the thermoplastic in the region of heat flow.

Ratio of Thermoplastic-thermal element Contact Area, Area of the thermoplastic and the thermal element exposed to the ambient environment:

$$\frac{{A}_{C T}}{{A}_{s} + {A}_{A C}} = \frac{\frac{{k}_{T P}}{{L}_{T P}} + \frac{{k}_{C}}{{L}_{C}}}{{h}_{inf} + {ϵ}_{T P} σ ( \frac{{T}_{S}^{4} - {T}_{inf}^{4}}{{T}_{S} - {T}_{inf}} ) + {ϵ}_{C} σ ( \frac{{T}_{C}^{4} - {T}_{inf}^{4}}{{T}_{C} - {T}_{inf}} )}$$

The temperature of the thermoplastic must reach tr such that

$${V}_{E} = \frac{{G}^{′} ( {t}_{T} )}{{G}^{′′} ( {t}_{T} )}$$

where V_{E}≥1.0 for “colder” ambient environments and V_{E}<1 for “hotter” ambient environments.

In terms of working of this invention's smart composite which exhibit self-deforming embodiments where deformation forces are applied intrinsically from the composite:

There are observed localised density changes:
Thermal Expansion: When a thermoplastic is heated, it generally undergoes thermal expansion, causing an increase in volume. Conversely, cooling tends to lead to thermal contraction and a decrease in volume;
Local Swelling: Depending on the thermoplastic, heating leads to local swelling as polymer chains separate and create void spaces. Conversely, cooling can lead to densification as chains contract and come closer together.

There are observed polymer chain-related changes:
Crystallisation: In some semi-crystalline thermoplastics, cooling can promote crystallisation, leading to a localised density increase as the polymer becomes more ordered;
Chain mobility: Local heating above the softening temperature results in increased chain mobility. Chains can move more freely and adopt a more disordered configuration;
Chain Entanglement: Cooling can lead to increased chain entanglement as polymer chains lose mobility and become more ordered.

An embodiment, of the composite of the invention, can have the thermal component, thermoplastic, conductor, thermal grease, and the like, in different physical states or combinations thereof.

While the present composite specification describes various heat transfer methods from/through a thermal component, it may be obvious to a person skilled in the art that the thermal component (14) may use any known heat transfer mechanisms and their combinations to achieve a controlled thermal gradient in a thermoplastic for V_{E}≥1.0 in cold environments and conversely, cool it in hot environments; allowing the thermoplastic component to exhibit a manipulated deformation, into a desired geometry upon application of force(s) or stress(es).

TECHNICAL ADVANTAGES: There are limited solutions for on-demand re-shapable materials; Thermoplastic casts, helmets, supports, splints, braces, due to their high stiffness provide higher amount of rigidity than plaster-based supports which allows the invention to have a relatively less volumetric footprint and also weigh less.

Thermoplastics are immune to the effects of everyday liquids like alcohols, oils, waters, detergents, soaps, milks and carbonated waters; thus, it allows the patient to be oblivious to everyday liquid spills thus also allowing the patient to safely and comfortably observe daily hygiene; Using thermoplastic in the form of a mesh/grid decreases the amount of material and thereby the cost, to an extent where it is economically competitive with the ubiquitously used plaster and fiberglass composites; The configuration of the invention allows it to have lower net skin surface coverage than that of the relevant region it is applied upon and is therefore very comfortable for the patient's skin—it lets the skin be exposed to air and reduces the risk of dermal complications and irritations substantially; The smooth and inert inner layer eliminates the need for padded wrappings; An internal heat source is implemented in the volume of the thermoplastic mesh or (regions of the thermoplastic mesh) and is controlled by an external vector to raise the temperature of the mesh/part of the mesh to a range between the Softening point and the Viscous points of the material in optimal time. The regions where these heat sources are implemented are essentially morphable, once the desirable temperature is attained. This thermosoftening nature of the material together allows these particular region(s) to become flexible upon the will of the personnel controlling the external vector, so as to be wrapped, applied and shaped as desired for the orthotic therapy; The mesh may be preformed and modified by the medical personnel as desired for individual cases before being used as an orthosis; The internal heat source allows the device to be removable and even reusable; The thermosoftening mechanism eliminates the use of crude tools for the orthosis application and removal process; Adjustability and the versatility of the morphable regions of the mesh reduces risk of compressive soft tissue injury, pressure sores, etc.; Ease of application-Pre-assembly and the rapid polymer cooling reduces lengthy complicated application procedures common in all encasing bandage/fiber based conventional orthopedic casting solutions and the custom fit orthosis like corrective helmet.

### Non-Limiting Exemplary Use-Cases

Solution for skin problems: The absolute coverage of affected regions under thick and hard materials such as plaster slabs, fiberglass, polymer helmets triggers skin irritation and dermal conditions like dermatitis, pressure sores and ulcers. This invention solves these problems.

Solution for high application and molding time: Plaster and fiberglass orthoses require a substantial amount of effort and time. It takes time in orders of up to tens of minutes for the conventional fiberglass and plaster-based orthoses to be applied, molded and completely cured. The job of making thermoplastic prosthetic leg attachments and orthotic callipers is also quite tedious requiring long man hours. Whereas devices like deformation correction helmets require days to be tailor made for the patient. This invention solves these problems.

Solution for high volume and footprint: Plaster slabs inherently have very high volume and weight which makes the daily functions of the patient more difficult who are already in discomfort. This invention solves these problems.

Solution for fragility: Plaster-based fracture casts are prone to breakage and also cannot retain their integrity in case of direct interaction with everyday liquids like alcohols, oils, water, detergents, soaps, milks and carbonated drinks. Fiberglass casts are also only partially resistant to water and other daily life liquids. This invention solves these problems.

Solution for high costs: Fiberglass casts that provide a certain degree of water resistance and higher strength are considerably expensive as compared to Plaster casts and not affordable to many. Repeat costs of single-use devices, devices that are not accommodative of growth. This invention solves these problems.

While the invention was developed for external orthopedic immobilization, it may be used very easily for various other applications such as customized chairs, shoes, morphable airfoils in aircraft, etc. The constructive combination of a thermoplastic with a second material acting as a respective heat source to enable on-demand thermosoftening of the thermoplastic can be easily used in various forms. This invention solves these problems.

The TECHNICAL ADVANCEMENT, of this invention, lies in providing a smart composite material which provides a combinatorial composite comprising a thermoplastic component, a thermal component, a heat source, and a heat sink, in an intelligent manner, such than there is an in-volume heating/cooling for creating desirable geometries.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A smart thermoplastic composite comprising:
a thermoplastic component having a first cross-sectional profile; and
a thermal component having a second cross-sectional profile and interfacing with the thermoplastic component, wherein, a cross-sectional arrangement of the thermoplastic composite is such that the thermal component modifies the thermal nature of the thermoplastic component in either a hot-active state or a cold-active state, creating a controlled thermal gradient within a region or volume of interest in the thermoplastic component, thereby establishing a pliable region of deformation within the thermoplastic component by,
increasing a localised temperature of the thermoplastic component above its softening point but below its viscous temperature, or
maintaining an ambient temperature above the softening point while maintaining a localised temperature of the thermoplastic component below the softening point.

2. The composite of claim 1, wherein the composite is engaged with:
an energy source configured to enable transmission of energy to the thermal component and the thermoplastic component;
an energy sink configured to enable absorption of energy from the thermal component and the thermoplastic component; and
a control mechanism configured to achieve a pliable region of deformation within the thermoplastic component, upon receipt of the transmitted energy, by creating a controlled thermal gradient within a region or volume of interest in the thermoplastic component, by,
controlling the transmission of energy in a first chosen unidirectional manner and controlling the absorption of energy in a second chosen unidirectional manner, wherein the first chosen unidirectional manner and the second chosen unidirectional manner are never the same direction, and
controlling the transmission of energy between a viscous point of the thermoplastic component and a softening point of the thermoplastic component.

3. The composite of claim 1, wherein the interfacing is selected from a group of interfacing types consisting of: thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, and partially ensconced interfacing with the thermal component partially ensconcing the thermoplastic component.

4. The composite of claim 1, wherein the thermal component is a non-thermoplastic component acting as an internal thermal source.

5. The composite of claim 1, wherein the thermal component is a non-thermoplastic component composed of a polar compound or a dielectric material that, when intercepted by electromagnetic radiation of a corresponding frequency, acts as a heat source.

6. The composite of claim 1, wherein the thermal component is a non-thermoplastic component in thermal contact with an external heat source and the thermoplastic component.

7. The composite of claim 2, wherein the thermoplastic component is activated in its hot active mode of working, in that energy control, via the control mechanism, from the energy source to the energy sink is controlled such that thermoplastic temperature is greater than thermoplastic softening temperature but is less than thermoplastic viscous temperature.

8. The composite of claim 2, wherein the thermoplastic component is activated in its hot active mode of working, in that energy control, via the control mechanism, from the energy source to the energy sink is controlled such that temperature of the energy source is greater than or equal to temperature of the thermal component, temperature of the thermal component is greater than or equal to temperature of the thermoplastic component, and temperature of the thermoplastic component is greater than or equal to temperature of the energy sink.

9. The composite of claim 2, wherein the thermoplastic component is activated in its cold active mode of working, in that energy control, via the control mechanism, from the energy sink to the energy source is controlled such that thermoplastic temperature is greater than thermoplastic viscous temperature but is less than thermoplastic softening temperature.

10. The composite of claim 2, wherein the thermoplastic component is activated in its cold active mode of working, in that energy control, via the control mechanism, from the energy sink to the energy source is controlled such that temperature of the energy source is less than or equal to temperature of the thermal component, temperature of the thermal component is less than or equal to temperature of the thermoplastic component, and temperature of the thermoplastic component is less than or equal to temperature of the energy sink.

11. The composite of claim 2, wherein for the thermal component acting as the energy source, the control mechanism is configured to achieve a pliable region of deformation within the thermoplastic component by maintaining a ratio of loss modulus of the thermoplastic component to storage modulus of the thermoplastic component at greater than or equal to 1.

12. The composite of claim 2, wherein for the thermal component acting as the energy sink, the control mechanism is configured to achieve a pliable region of deformation within the thermoplastic component by maintaining a ratio of loss modulus of the thermoplastic component to storage modulus of the thermoplastic component at less than 1.

13. The composite of claim 2, wherein the control mechanism is configured to achieve a pliable region of deformation within the thermoplastic component, upon receipt of the transmitted energy, by creating a controlled thermal gradient within a region or volume of interest in the thermoplastic component, by:
controlling the transmission of energy in a first chosen unidirectional manner and controlling the absorption of energy in a second chosen unidirectional manner, wherein the first chosen unidirectional manner and the second chosen unidirectional manner are never the same direction; and
controlling the transmission of energy between a viscous point of the thermoplastic component and a softening point of the thermoplastic component.

14. The composite of claim 2, wherein the control mechanism is configured to achieve a pliable region of deformation within the thermoplastic component by creating a controlled thermal gradient within a region or volume of interest in the thermoplastic component by,
increasing a localised temperature of the thermoplastic component above its softening point but below its viscous temperature, or
maintaining an ambient temperature above the softening point while maintaining a localised temperature of the thermoplastic component below the softening point.
